(19) United States
(12) Patent Application Publication
(10) Pub. No.: US 2026/0116649 A1
(43) Pub. Date: Apr. 30, 2026

(54) DOG WASTE BAG CARRIER DEVICE

(71) Applicant: Bradley Barnes, Santa Ynez, CA (US)

(72) Inventor: Bradley Barnes, Santa Ynez, CA (US)

(21) Appl. No.: 19/050,362

(22) Filed: Feb. 11, 2025

Related U.S. Application Data
(60) Provisional application No. 63/711,392, filed on Oct. 24, 2024.

(51) Int. Cl. B65F 1/00; B65F 1/06

(52) U.S. Cl. CPC B65F 1/0026; B65F 1/062; B65F 2220/1063; B65F 2240/136; B65F 2250/105

(57) ABSTRACT

A dog waste bag carrier device is provided. The device is designed to provide a sanitary, discreet, and hands-free solution for temporarily storing used dog waste bags until proper disposal is available. The device comprises a collapsible, accordion-style body made from silicone for flexibility, durability, and ease of cleaning. A base section is attachable via snap-fit or twist-lock mechanisms and serves as an optional secondary compartment for treats, water, or additional waste bags. The lid assembly includes a two-section design, with one section securing to the body and the other housing a roll of waste bags, which are dispensed through an integrated slot. The waste bags are preferably biodegradable and may include an odor-barrier film or fragrance for enhanced user experience. Silicone gaskets ensure an airtight and watertight seal to prevent odor and leakage. The device attaches easily to a leash, belt, or bag via a carabiner, for convenient transport.

### CROSS-REFERENCE TO RELATED APPLICATION

The present application claims priority to, and the benefit of, U.S. Provisional Application No. 63/711,392, which was filed on Oct. 24, 2024, and is incorporated herein by reference in its entirety.

### FIELD OF THE INVENTION

The present invention relates generally to the field of pet waste collection devices. More specifically, the present invention relates to a hands-free device for temporarily storing used dog waste bags, featuring a collapsible silicone body, an optional secondary compartment, and a two-section lid with an integrated waste bag dispenser. Accordingly, the present disclosure makes specific reference thereto. Nonetheless, it is to be appreciated that aspects of the present invention are also equally applicable to other like applications, devices, and methods of manufacture.

### BACKGROUND

Pet owners frequently take their dogs on walks or visit public spaces such as parks, beaches, and hiking trails. While these outings provide exercise and companionship, they also come with the responsibility of cleaning up after the pet. Most jurisdictions require pet waste to be collected and properly disposed of to maintain hygiene and prevent environmental contamination. However, carrying a used waste bag until a disposal bin is available is often inconvenient, unsanitary, and unpleasant due to odors and leakage risks. Traditional dog waste bags offer no practical solution for temporary storage, forcing pet owners to hold the bag in their hands or attach it to their leash or backpack in an exposed manner. This can be particularly troublesome during long walks or in areas where waste disposal bins are scarce. Additionally, many existing solutions lack odor and waterproof barriers, leading to further discomfort for the user. Given the widespread need for a hygienic and discreet method of carrying used dog waste bags, an improved solution is necessary.

Therefore, there exists a long-felt need in the art for an improved dog waste bag carrier that provides a sanitary and hands-free way to transport used waste bags. There also exists a long-felt need in the art for an improved dog waste bag carrier that effectively contains odors and prevents leakage. Moreover, there exists a long-felt need in the art for an improved dog waste bag carrier that incorporates additional storage functionality for pet-related items such as treats, water, or extra waste bags.

The subject matter disclosed and claimed herein, in one embodiment thereof, comprises a dog waste bag carrier device. The device is designed to provide a sanitary, discreet, and hands-free solution for temporarily storing used dog waste bags until proper disposal is available. The device comprises a collapsible, accordion-style body made from silicone for flexibility, durability, and ease of cleaning. A base section is attachable via snap-fit or twist-lock mechanisms and serves as an optional secondary compartment for treats, water, or additional waste bags. The lid assembly includes a two-section design, with one section securing to the body and the other housing a roll of waste bags, which are dispensed through an integrated slot. The waste bags are preferably biodegradable and may include an odor-barrier film or fragrance for enhanced user experience. Silicone gaskets further ensure an airtight and watertight seal to prevent odor and leakage. The device attaches easily to a leash, belt, or bag via a carabiner, allowing for convenient transport.

In this manner, the dog waste bag carrier device of the present invention accomplishes all the forgoing objectives and provides a secure, airtight, and waterproof storage compartment for used waste bags. More specifically, the collapsible body allows for space-efficient storage when not in use while expanding as needed to accommodate various waste bag sizes. The incorporation of silicone gaskets ensures an odor-proof and leak-resistant seal, enhancing user comfort during transport. Additionally, the device features a built-in waste bag dispenser for convenient access to fresh bags, reducing waste and improving efficiency. A secondary compartment offers optional storage for treats, water, or additional waste bags, increasing the device's functionality. Furthermore, the attachment mechanism allows for hands-free carrying by securing the device to a leash, belt, or bag. By addressing issues of hygiene, convenience, and storage, the improved dog waste bag carrier provides a comprehensive solution for responsible pet owners.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dog waste bag carrier device. The dog waste bag carrier device provides a sanitary, discreet, and hands-free solution for temporarily storing used dog waste bags until disposal. Designed for pet owners on walks or outdoor activities, the device attaches to a leash, backpack, or belt for convenient transport without hindering mobility.

The device is comprised of a body that serves as the primary storage chamber for waste bags. The body features a collapsible, accordion-style structure that expands to accommodate various waste bag sizes while maintaining a compact profile when empty. Preferably made from silicone for flexibility, durability, and resistance to bacteria, the body allows for easy cleaning. In an alternative configuration, the body may be rigid for users preferring a structured container.

A base is attached to the body. In one embodiment, the base is connected via a snap-fit mechanism for secure attachment and easy removal. In another embodiment, the base and body incorporate reciprocating fasteners, such as threads, providing a twist-lock connection. The base can serve as an optional secondary compartment, collapsible through an accordion structure, and used for storing dog treats, water, food, or additional waste bags. When not in use, the base fully collapses into the body.

The device includes a two-section lid assembly that ensures secure closure and integrates a waste bag dispensing function. The first section of the lid attaches to the body via a snap-fit connection or reciprocating fasteners. An attachment point on the first section allows for the connection of a carabiner, enabling hands-free transport. The second section houses a roll of waste bags in a hollow compartment, dispensing them individually through an integrated slot. The first section serves as the bottom wall of the compartment. In one embodiment, the lid components are secured to the device via a tether to prevent misplacement.

The waste bags fit within the hollow compartment of the second section and dispense through the slot. Preferably made from biodegradable materials such as plant-based polymers, polylactic acid, or cornstarch-based composites, the waste bags offer an environmentally friendly alternative. In another embodiment, they may be made from high-density or low-density polyethylene for durability. A multilayer construction incorporating an odor-barrier film may be included to contain unpleasant smells. Some embodiments feature fragrance infusions, such as lavender, citrus, or eucalyptus, to neutralize odors. Waste bags are dispensed individually from a roll to minimize waste and enhance efficiency.

By integrating odor-proof, waterproof, and collapsible storage features, the device offers a practical solution for carrying used dog waste bags. Users avoid holding waste bags while searching for a disposal bin, ensuring a more sanitary experience. The combination of a collapsible storage chamber, a secondary compartment, and an integrated waste bag dispenser enhances functionality, making the device a valuable pet accessory.

The invention also includes a method of use. The device is provided with a body, at least one base, and a lid assembly comprising a first and second section. A roll of waste bags is inserted into the hollow compartment of the second section, which is secured onto the first section. The first section attaches to the body via a snap-fit connection or reciprocating fasteners, forming a sealed storage chamber. The base may be expanded for storage and collapsed when not in use. The device is then attached to a leash, belt, or bag via a carabiner for hands-free transport. Waste bags are withdrawn individually from the dispensing slot, removed from the roll, and used to collect waste. Once filled, the bag is inserted into the body through an opening created by temporarily detaching the first section. The first section is reattached, forming an airtight and watertight seal. The waste bag remains stored within the body until disposal, at which point the first section is removed, and the bag is discarded.

Accordingly, the dog waste bag carrier device of the present invention is particularly advantageous as it provides a secure, airtight, and waterproof storage compartment for used waste bags. More specifically, the collapsible body allows for space-efficient storage when not in use while expanding as needed to accommodate various waste bag sizes. The incorporation of silicone gaskets ensures an odor-proof and leak-resistant seal, enhancing user comfort during transport. Additionally, the device features a built-in waste bag dispenser for convenient access to fresh bags, reducing waste and improving efficiency. A secondary compartment offers optional storage for treats, water, or additional waste bags, increasing the device's functionality. Furthermore, the attachment mechanism allows for hands-free carrying by securing the device to a leash, belt, or bag. By addressing issues of hygiene, convenience, and storage, the improved dog waste bag carrier provides a comprehensive solution for responsible pet owners. In this manner, the dog waste bag carrier device overcomes the limitations of existing methods and devices used for temporary waste bag storage known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exploded view of one potential embodiment of a dog waste bag carrier device of the present invention in accordance with the disclosed architecture;

FIG. 2 illustrates a perspective view of one potential embodiment of a dog waste bag carrier device of the present invention while fully extended in accordance with the disclosed architecture;

FIG. 3 illustrates a perspective view of one potential embodiment of a dog waste bag carrier device of the present invention while fully collapsed in accordance with the disclosed architecture; and

FIG. 4 illustrates a flowchart of a method of using one potential embodiment of a dog waste bag carrier device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved dog waste bag carrier that provides a sanitary and hands-free way to transport used waste bags. There also exists a long-felt need in the art for an improved dog waste bag carrier that effectively contains odors and prevents leakage. Moreover, there exists a long-felt need in the art for an improved dog waste bag carrier that incorporates additional storage functionality for pet-related items such as treats, water, or extra waste bags.

The present invention, in one exemplary embodiment, is comprised of a dog waste bag carrier device. The dog waste bag carrier device provides a sanitary, discreet, and hands-free solution for temporarily storing used dog waste bags until disposal. Designed for pet owners during walks or outdoor activities, the device attaches to a leash, backpack, or belt for convenient transport without restricting mobility.

The device is comprised of a body that functions as the primary storage chamber for waste bags. The body features a collapsible, accordion-style structure that expands to accommodate various waste bag sizes while remaining compact when empty. Preferably constructed from silicone for flexibility, durability, and resistance to bacteria, the body allows for easy cleaning. Alternatively, a rigid version may be provided for users preferring a structured container.

A base is attached to the body. In one embodiment, the base connects via a snap-fit mechanism for secure attachment and easy removal. In another embodiment, reciprocating fasteners, such as threads, provide a twist-lock connection. The base may also serve as an optional secondary compartment, collapsible through an accordion structure, for storing dog treats, water, food, or additional waste bags. When not in use, the base fully collapses into the body.

The device includes a two-section lid assembly that ensures secure closure and integrates a waste bag dispensing function. The first section attaches to the body via a snap-fit connection or reciprocating fasteners. An attachment point on the first section allows for the connection of a carabiner, enabling hands-free transport. The second section houses a roll of waste bags within a hollow compartment, dispensing them individually through an integrated slot. The first section serves as the bottom wall of this compartment. In one embodiment, the lid components are secured to the device via a tether to prevent misplacement.

The waste bags are contained within the hollow compartment of the second section and are dispensed through the slot. Preferably made from biodegradable materials such as plant-based polymers, polylactic acid, or cornstarch-based composites, the waste bags provide an environmentally friendly alternative. In another embodiment, they may be constructed from high-density or low-density polyethylene for durability. A multilayer construction incorporating an odor-barrier film may be included to contain unpleasant smells. Some embodiments feature fragrance infusions, such as lavender, citrus, or eucalyptus, to neutralize odors. Waste bags are dispensed individually from a roll to minimize waste and enhance efficiency.

By integrating odor-proof, waterproof, and collapsible storage features, the device provides a practical solution for carrying used dog waste bags. Users can avoid holding waste bags while locating a disposal bin, ensuring a more sanitary experience. The combination of a collapsible storage chamber, a secondary compartment, and an integrated waste bag dispenser enhances functionality, making the device a valuable pet accessory.

The invention also includes a method of use. The device is provided with a body, at least one base, and a lid assembly comprising a first and second section. A roll of waste bags is inserted into the hollow compartment of the second section, which is then secured onto the first section. The first section attaches to the body via a snap-fit connection or reciprocating fasteners, forming a sealed storage chamber. The base may be expanded for storage and collapsed when not in use. The device is then secured to a leash, belt, or bag via a carabiner for hands-free transport. Waste bags are withdrawn individually from the dispensing slot, removed from the roll, and used to collect waste. Once filled, the bag is inserted into the body through an opening created by temporarily detaching the first section. The first section is then reattached, forming an airtight and watertight seal. The waste bag remains stored within the body until disposal, at which point the first section is removed, and the bag is discarded.

The dog waste bag carrier device provides a secure, airtight, and waterproof storage compartment for used waste bags. The collapsible body enables space-efficient storage when not in use while expanding as needed to accommodate various waste bag sizes. The incorporation of silicone gaskets ensures an odor-proof and leak-resistant seal, enhancing user comfort during transport. Additionally, the device features a built-in waste bag dispenser for convenient access to fresh bags, reducing waste and improving efficiency. A secondary compartment offers optional storage for treats, water, or additional waste bags, increasing functionality. Furthermore, the attachment mechanism allows for hands-free carrying by securing the device to a leash, belt, or bag. By addressing hygiene, convenience, and storage concerns, the improved dog waste bag carrier provides a comprehensive solution for responsible pet owners, overcoming the limitations of existing methods and devices for temporary waste bag storage.

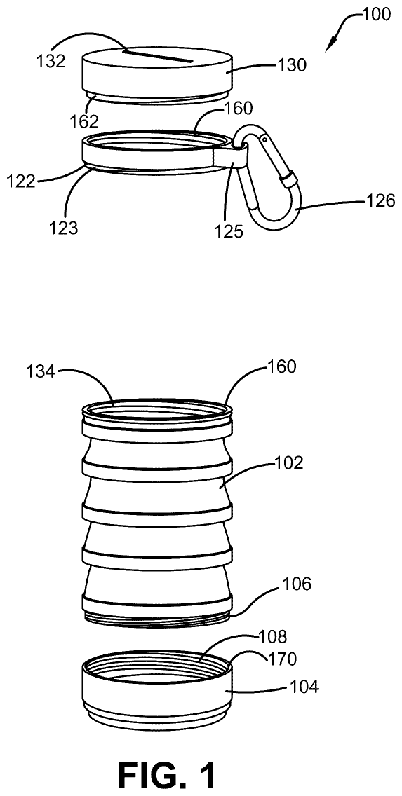

Referring initially to the drawings, FIG. 1 illustrates an exploded view of one potential embodiment of a dog waste bag carrier device 100 of the present invention in accordance with the disclosed architecture. The dog waste bag carrier device 100 is designed to provide a sanitary, discreet, and hands-free solution for temporarily storing used dog waste bags until proper disposal is available. The device 100 is particularly beneficial for pet owners who take their dogs on walks, hikes, or other outdoor activities where immediate access to a waste bin may not be possible. The device 100 is configured to attach easily to a leash, backpack, or belt, allowing for convenient transport without interfering with the user's mobility.

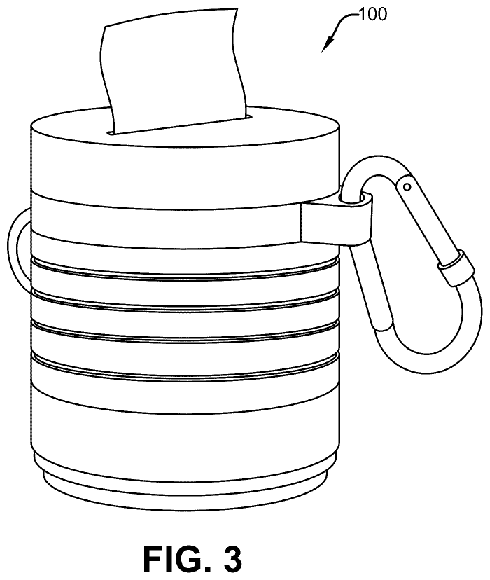

The device 100 is comprised of a body 102 that serves as the primary storage chamber for dog waste bags. The body 102 is preferably a collapsible, accordion-style structure that allows the device 100 to expand as needed to accommodate waste bags of varying sizes while maintaining a compact profile when not in use. The collapsible nature of the body 102, as seen in FIG. 3, ensures that the device 100 remains space-efficient when empty, making it easy to transport and store. The body 102 is preferably made from silicone, which provides flexibility, durability, and resistance to bacteria buildup. The silicone construction also allows for easy cleaning and maintenance, ensuring that the device 100 remains hygienic with repeated use. In an alternative configuration, the body 102 may be rigid, providing a more structured form for users who prefer a solid container.

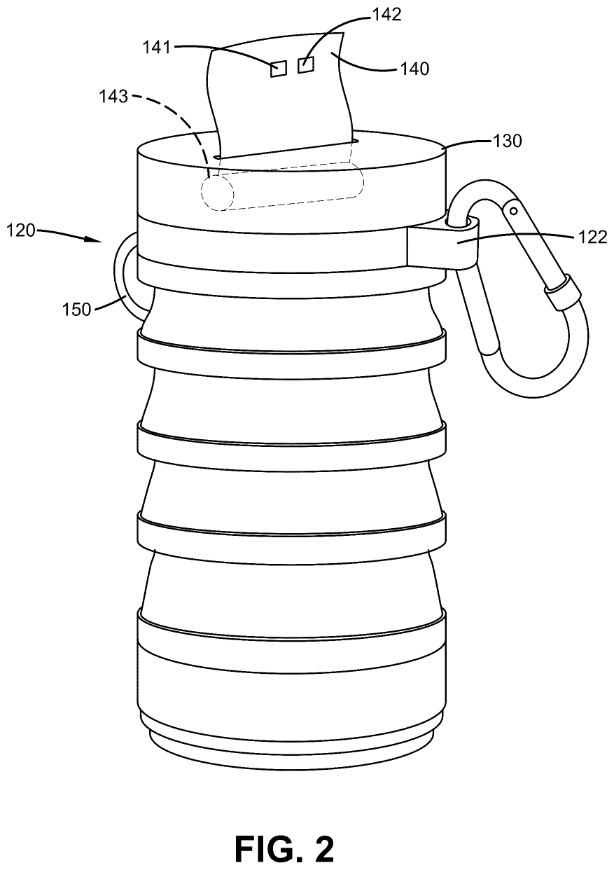

At least one base 104 is attached to the body 102. In one embodiment, the base 104 is connected via a snap-fit mechanism, allowing for secure attachment while facilitating easy removal when necessary. In another embodiment, the base 104 and the body 102 are comprised of a pair of reciprocating fasteners 106, 108, such as but not limited to threads, providing a secure, twist-lock connection. The base 104 also serves as an optional secondary compartment. Like the body 102, the base 104 is collapsible through an accordion structure, allowing it to expand when in use, as seen in FIG. 2, and collapse when not needed, as seen in FIG. 3. The base 104 can be used to store dog treats, water, food, or additional waste bags, offering additional functionality beyond waste containment. When not in use, the base 104 can be fully collapsed into the body 102.

The device 100 also includes a two-section lid assembly 120 that provides both secure closure and integrated waste bag dispensing functionality. The lid assembly 120 is comprised of a first section 122 designed to attach securely to the body 102 of the device 100 through a snap-fit connection or a pair of reciprocating fasteners 123, 134, such as but not limited to threads. The first section 122 of the lid 120 further includes an attachment point 125, such as but not limited to a loop, allowing for the connection of a carabiner 126. This configuration enables the device 100 to be clipped onto a leash, belt, or bag for hands-free transport. The second section 130 of the lid assembly 120 features a hollow compartment designed specifically to house a roll of dog waste bags 140. The second section 130 does not include a bottom wall, with the top wall of the first section 122 instead serving as the bottom wall of the compartment. The second section 130 attaches to the first section 120 via snap-fit or via a pair of reciprocating fasteners 160,162 such as but not limited to threads. A dispensing slot 132 is integrated into the second section 130, allowing for the withdrawal of individual waste bags 140 as needed. In one embodiment, the first section 122 and/or the second section 130 are secured to the body 102 via a tether 150 or a similar structure, ensuring that the lid components remain attached to the device 100 and do not become misplaced during use.

The waste bag 140 is configured to fit within the hollow compartment of the second section 130 of the lid assembly 120 and is dispensed through the dispensing slot 132. The waste bag 140 is preferably made from biodegradable materials, such as plant-based polymers, polylactic acid (PLA), or cornstarch-based composites, to provide an environmentally friendly alternative to traditional plastic bags. In another embodiment, the waste bag 140 may be made from high-density polyethylene (HDPE) or low-density polyethylene (LDPE) for increased durability and tear resistance. The waste bag 140 may further include a multilayer construction that incorporates an odor-barrier film 141 to contain unpleasant smells. In some embodiments, the waste bag 140 may be infused with a fragrance 142, such as lavender, citrus, or eucalyptus, to further neutralize odors and provide a more pleasant user experience. The waste bag 140 is configured to be dispensed individually from a roll 143, ensuring that only a single bag 140 is retrieved at a time to minimize waste and improve efficiency during use.

To prevent the escape of odors and liquids, the device 100 incorporates silicone gaskets 160, which create an airtight and watertight seal between the first section 122 of the lid assembly 120 and the base 104. This sealing mechanism ensures that waste bags stored within the body 102 remain securely contained, preventing the release of odors and eliminating leakage risks. Further, the waterproof construction of the body 102 ensures that no liquid seeps into or out of the chamber, making the device 100 suitable for use in various environmental conditions, including rain and humid climates.

By integrating odor-proof, waterproof, and collapsible storage features, the dog waste bag carrier device 100 provides a comprehensive solution to the common inconvenience of carrying used dog waste bags during walks or outdoor activities. The device 100 eliminates the need for users to hold waste bags in hand while searching for a disposal bin, offering a more sanitary and practical alternative. The combination of a collapsible storage chamber, a secondary compartment for treats or water, and an integrated waste bag dispenser enhances the functionality of the device 100, making it a valuable accessory for responsible pet owners.

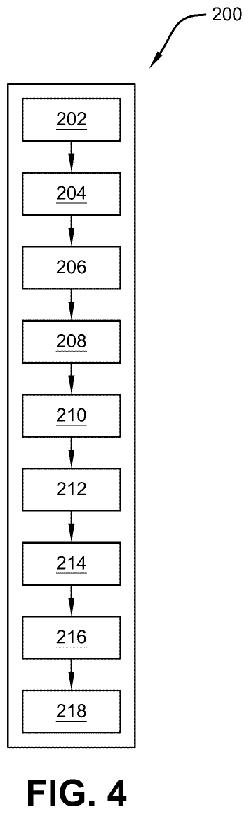

The present invention is also comprised of a method of using 200 the device 100, as seen in FIG. 4. First, a device 100 is provided comprised of a body 102, at least one base 104, and a lid assembly 120, wherein the lid assembly 120 is comprised of a first section 122 and a second section 130 [Step 202]. Then, a roll 143 of waste bags 140 is inserted into the hollow compartment of the second section 130 of the lid assembly 120, and the second section 130 is secured onto the first section 122 [Step 204]. Next, the first section 122 is secured onto the body 102 via a snap-fit connection or a pair of reciprocating fasteners 123, 134 such as but not limited to threads, forming a sealed storage chamber [Step 206]. The base 104 may optionally be expanded and used to store treats, water, or additional waste bags before being collapsed when not in use [Step 208]. The user may then attach the device 100 to a leash, belt, or bag via a carabiner 126, allowing for hands-free transport [Step 210]. When needed, an individual waste bag 140 is withdrawn from the dispensing slot 132 of the second section 130, removed from the roll, and used to collect dog waste [Step 212]. Once the waste bag 140 is filled, it is inserted into the body 102 of the device 100 through an opening created by temporarily detaching the first section 122 from the body 102 [Step 214]. The first section 122 is then reattached, ensuring that the silicone gasket 170 forms an airtight and watertight seal to contain odors and prevent leaks [Step 216]. Finally, the waste bag 140 remains securely stored within the body 102 until the user locates a proper disposal bin, at which point the first section 122 is removed, and the waste bag 140 is discarded [Step 218].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dog waste bag carrier device” and “device” are interchangeable and refer to the dog waste bag carrier device 100 of the present invention.

Notwithstanding the forgoing, the dog waste bag carrier device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the dog waste bag carrier device 100 as shown in the FIGS. are for illustrative purposes only, and that many other sizes and shapes of the dog waste bag carrier device 100 are well within the scope of the present disclosure. Although the dimensions of the dog waste bag carrier device 100 are important design parameters for user convenience, the dog waste bag carrier device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dog waste bag carrier device comprising:
a body being selectively collapsible and expandable;
a base attached to the body, the base being selectively collapsible and expandable; and
a lid assembly removably attached to the body, the lid assembly comprising:
a first section attached to the body; and
a second section defining a hollow compartment for housing a roll of a waste bag, the second section comprised of a dispensing slot.

2. The dog waste bag carrier device of claim 1, wherein the body and the base attach to each other via a first pair of threads.

3. The dog waste bag carrier device of claim 1, wherein the first section and the base attach to each other via a second pair of threads.

4. The dog waste bag carrier device of claim 1, wherein the first section and the second section attach to each other via a third pair of threads.

5. The dog waste bag carrier device of claim 1 further comprised of a gasket.

6. The dog waste bag carrier device of claim 1, wherein the waste bag is comprised of a biodegradable material.

7. The dog waste bag carrier device of claim 1, wherein the waste bag is comprised of a fragrance.

8. The dog waste bag carrier device of claim 1, wherein the waste bag is comprised of an odor-barrier film.

9. A dog waste bag carrier device comprising:
a body being selectively collapsible and expandable;
a base attached to the body, the base being selectively collapsible and expandable; and
a lid assembly removably attached to the body, the lid assembly comprising:
a first section attached to the body comprised of an attachment point and a carabiner; and
a second section defining a hollow compartment for housing a roll of waste bags, the second section comprised of a dispensing slot.

10. The dog waste bag carrier device of claim 9, wherein the body is comprised of an accordion construction.

11. The dog waste bag carrier device of claim 9, wherein the base is comprised of an accordion construction.

12. The dog waste bag carrier device of claim 9, wherein the body is comprised of a flexible material.

13. The dog waste bag carrier device of claim 9, wherein the base attaches to the body via a snap-fit connection.

14. The dog waste bag carrier device of claim 9, wherein the first section attaches to the base via a snap-fit connection.

15. The dog waste bag carrier device of claim 9, wherein the second section attaches to the first section via a snap-fit connection.

16. The dog waste bag carrier device of claim 9 further comprised of a first gasket.

17. The dog waste bag carrier device of claim 16, wherein the first gasket is positioned between the body and the first section.

18. The dog waste bag carrier device of claim 9 further comprised of a second gasket.

19. The dog waste bag carrier device of claim 18, wherein the second gasket is positioned between the first section and the body.

20. A method of using a dog waste bag carrier device, the method comprising:
providing a dog waste bag carrier device comprised of a body, a base, and a lid assembly, wherein the lid assembly comprises a first section and a second section;
inserting a roll of waste bags into the second section and securing the second section to the first section;
securing the first section onto the body;
withdrawing an individual waste bag from a dispensing slot of the second section and using the waste bag to collect a dog waste;
inserting the waste bag into the body by temporarily detaching the first section from the body; and
reattaching the first section to form an airtight and watertight seal with the body via the waste bag inside.
